(19) United States
(12) Patent Application Publication
(10) Pub. No.: US 2003/0069357 A1
(43) Pub. Date: Apr. 10, 2003

(54) Aromatic oligomer, phenolic resin composition containing the same, and epoxy resin composition and cured product obtained therefrom

(76) Inventors: Masashi Kaji, Fukuoka (JP); Kiyokazu Yonekura, Fukuoka (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/257,053

(22) PCT Filed: Apr. 10, 2001
(86) PCT No.: PCT/JP01/03072

(51) Int. Cl. C08F 8/00

(52) U.S. Cl. 525/107

(57) ABSTRACT

This invention relates to an aromatic oligomer which is useful as a modifier of epoxy resin compositions, to a phenolic resin composition comprising said aromatic oligomer and to an epoxy resin composition comprising said aromatic oligomer and is useful for encapsulating electric and electronic parts and as a circuit board material. The aromatic oligomer of this invention is obtained by polymerizing monomers mainly consisting of aromatic olefins comprising 20 wt % or more of acenaphthylenes and shows a softening point of 80-250° C. The phenolic resin composition or epoxy resin composition of this invention is obtained by incorporating 3-200 parts by weight of the aromatic oligomer per 100 parts by weight of phenolic resin or epoxy resin. The cured epoxy resin of this invention is obtained by curing the epoxy resin composition.

### FIELD OF TECHNOLOGY

This invention relates to organic oligomers useful as modifiers of epoxy resins. This invention also relates to epoxy resin compositions which yield cured products with excellent properties in respect to moisture absorption, heat resistance, adhesiveness, flame retardance and dielectric property and are useful for encapsulating electric and electronic parts and as circuit board materials and to cured products obtained therefrom.

### BACKGROUND TECHNOLOGY

Epoxy resins have been used industrially in a wide variety of applications, but requirements for their performance are becoming increasingly more stringent in recent years. For example, a typical area of usage for resin compositions mainly consisting of epoxy resins is encapsulation of semiconductors. With an increase in the scale of miniaturization of semiconductor devices, packages are becoming larger in area and smaller in thickness while the packaging method is shifting to surface mounting and there has arisen a demand for development of materials with excellent resistance to soldering heat. In consequence, what is strongly demanded for encapsulating materials in addition to low moisture absorption is improved adhesiveness at the interface of materials of different kind such as lead frames and chips. Likewise, in the area of circuit board materials, there is a great demand for development of materials with low moisture absorption, high heat resistance and good adhesiveness from the viewpoint of improved resistance to soldering heat and low dielectric property from the viewpoint of reduced dielectric loss. In order to meet these demands, the suppliers of epoxy resins or the main constituents of epoxy resin compositions are looking into epoxy resins of a variety of novel structures. In their efforts to improve the properties, however, the heat resistance deteriorated as the moisture absorption improved or the curing characteristics deteriorated as the adhesiveness improved and balancing of the properties was found difficult to achieve by tampering with epoxy resins alone. Moreover, there has been a trend in recent years to exclude the use of halogen-containing flame retardants from the viewpoint of reducing the environmental load and this has created a demand for modifiers with improved flame retardance.

Under the aforementioned circumstances, a variety of epoxy resin modifiers are under investigation. Indene-coumarone resin is known as an example of such modifiers and an application of coumarone-indene-styrene copolymer as an encapsulant of semiconductors is shown in JP1-249824 A. However, organic oligomers known thus far generally show a softening point of 120° C. or so at its maximum and incorporation of such oligomer in epoxy resin presented the problem of lowering the heat resistance (glass transition temperature) of the cured product. Moreover, in case an aromatic oligomer of a low softening point is used as a modifier of epoxy resin, the oligomer exuded during molding or during pressing when used as a substrate material and hence presented the problem of deteriorating the moldability and fabricability. Still more, its flame retardance was not sufficient.

On the other hand, an increase in the content of indene structure in organic oligomers is known to raise the softening point of the oligomers and indene resin with a softening point of as high as 142° C. is described in JP6-107905 A. And yet, the indene resin in question produces a small effect of improving the heat resistance and nearly no effect of improving the flame retardance.

### DISCLOSURE OF THE INVENTION

An object of this invention is to provide an aromatic oligomer which is useful as a modifier for an epoxy resin composition. Another object of this invention is to provide an epoxy resin composition which exhibits excellent moldability, yields a cured product with low moisture absorption, good heat resistance, adhesiveness and flame retardance and low dielectric property and is useful for encapsulating electric and electronic parts and useful as a circuit board material and to provide said cured product. A further object of this invention is to provide a phenolic resin composition which is useful as a curing agent for epoxy resin.

Accordingly, this invention relates to an organic oligomer with a softening point of 80-250° C. obtained by polymerizing monomers mainly containing aromatic olefins comprising 20 wt % or more of acenaphthylenes. Moreover, this invention relates to a phenolic or epoxy resin composition formulated from a phenolic or epoxy resin and the aromatic oligomer and to the cured epoxy resin.

### DETAILED DESCRIPTION OF THE INVENTION

The aromatic oligomer of this invention is obtained by polymerizing monomers mainly containing aromatic olefins comprising 20 wt % or more of acenaphthyelenes. The effects of this invention, namely, improvements in properties such as heat resistance, adhesiveness, moisture resistance and flame retardance, depend in large measure on the content of acenaphthylene structure in the aromatic oligomer and the higher the content of acenaphthylene structure, the better the properties are balanced; the content is generally 20 wt % or more, preferably 40 wt % or more, more preferably 60 wt % or more.

Preferably, olefins to be polymerized or copolymerized to give the aromatic oligomer include a) aromatic olefins consisting of acenaphthylenes and b) 20-90 wt % of acenaphthylenes and 10-80 wt % of comonomers selected from indenes and styrenes.

The softening point of the aromatic oligomer of this invention is in the range from 80 to 250° C., preferably from 90 to 180° C., more preferably from 110 to 160° C. When incorporated in epoxy resin, an aromatic oligomer with a softening point lower than the aforementioned reduces the heat resistance of the cured product and deteriorates the moldability by bleeding and the like of the aromatic oligomer while the one with a higher softening point reduces the fluidity during molding.

The type of polymerization applicable to the synthesis of the aromatic oligomer of this invention can be radical, cationic or anionic, cationic polymerization being advantageous. The catalyst for cationic polymerization is selected suitably from known inorganic and organic acids, for example, mineral acids such as hydrochloric acid, sulfuric acid and phosphoric acid, organic acids such as formic acid, oxalic acid, trifluoroacetic acid, p-toluenesulfonic acid and methanesulfonic acid, Lewis acids such as zinc chloride, aluminum chloride, iron chloride and boron trifluoride and solid acids such as activated clay, silica-alumina and zeolite. Boron trifluoride is desirable for cationic polymerization as it is highly reactive and causes less coloration of the product oligomer than other catalysts.

After completion of cationic polymerization, the catalyst is removed by addition of an excess of calcium hydroxide to form a difficultly soluble neutral salt followed by filtration. The polymerization is usually carried out at 10-200° C. for 1-20 hours.

The polymerization can be effected by heating alone in the absence of a catalyst. In this case, the temperature is 60-200° C., preferably 80-160° C. At a temperature lower than this, a longer time is required for the polymerization. On the other hand, at a temperature higher than this, the reaction becomes difficult to control and occasionally the reaction product undergoes gelation to form an insoluble and infusible mass. The polymerization time is normally 1-20 hours.

A solvent may be used in the polymerization; for example, an alcohol such as methanol, ethanol, propanol, butanol, ethylene glycol, Methyl Cellosolve and Ethyl Cellosolve, a ketone such as acetone, methyl ethyl ketone and methyl isobutyl ketone, an ether such as dimethyl ether, diethyl ether, diisopropyl ether, tetrahydrofuran and dioxane and an aromatic compound such as benzene, toluene, chlorobenzene and dichlorobenzene.

Of the monomers to be used in the preparation of the aromatic oligomers of this invention, acenaphthylenes are essential and include acenaphthylene and hydrocarbon-substituted acenaphthylenes such as methylacenaphthylene, ethylacenaphthylene, propylacenaphthylene and phenylacenaphthylene. These acenaphthylenes are usually synthesized by dehydrogenating the corresponding acenaphthenes.

Aromatic olefins other than the acenaphthylenes may be present in the monomers to be used in the preparation of the aromatic oligomer of this invention. Such aromatic olefins include monomers containing an unsaturated linkage such as indene, alkylindenes, benzothiophene, methylbenzothiophenes, benzofuran, methylbenzofurans, styrene, alkylstyrenes, α-methylstyrene, vinylnaphthalene and vinylbiphenyl.

Moreover, the aforementioned monomers may contain monomers other than the aromatic olefins (including acenaphthylenes) in small amounts to such an extent as not to contradict the object of this invention. Other monomers of this kind include aliphatic olefins such as acrylic acid, acrylate esters, methacrylic acid, methacrylate esters, maleic anhydride and fumaric acid and diolefins such as divinylbenzenes and diisopropenylbenzene. It is advisable to limit the amount of other monomers to 30 wt % or less, preferably 10 wt % or less.

The aforementioned monomers can be used singly or as a mixture of two kinds or more. If the first consideration is given to the properties of the cured product obtained from a resin composition containing the aromatic oligomer, the properties improve as the content of acenaphthylene skeleton in the aromatic oligomer increases and the acenaphthylenes are fed so that they account for 20 wt % or more, preferably 40 wt % or more, more preferably 60 wt % or more, of the reactants participating in the polymerization. On the other hand, if a synthetic procedure is taken into consideration, the molecular weight distribution is difficult to control in the polymerization of acenaphthylenes alone and it is preferable to effect the polymerization in the presence of comonomers other than the aforementioned acenaphthylenes. Preferable comonomers are indenes or styrenes and their content is preferably 10-80 wt %, more preferably 20-60 wt %.

Co-presence of phenols is allowable in the polymerization. Such phenols include phenol, alkylphenols such as cresol, dialkylphenols such as xylenol, naphthols, naphthalenediols, bisphenols such as bisphenol A and bisphenol F and polyfunctional phenolic compounds such as phenol novolak and phenol-aralkyl resin. These phenolic compounds are usually added in an amount of 20 wt % or less, but there is no specific restriction in this regard. Phenols themselves are not polymerizable because of the absence of unsaturated linkage, but they react with aromatic olefins or their oligomers in the presence of a cationic catalyst to form aromatic oligomers containing phenols at ends.

After completion of the polymerization reaction, the unreacted acenaphthylenes remain in the product aromatic oligomer in some cases. The residual acenaphthylenes can be removed out of the system by a means such as distillation under reduced pressure and partition by solvent, but the aromatic oligomer still containing the unreacted acenaphthylenes can be incorporated in the phenolic resin composition or epoxy resin composition of this invention if circumstances require. In a case such as this, the amount of residual acenaphthylenes is normally 30 wt % or less, preferably 10 wt % or less, more preferably 5 wt % or less. Where the amount exceeds this, the cured product deteriorates in heat resistance and flame retardance.

The phenolic resin composition of this invention is a phenolic resin composition comprising a polyvalent phenolic compound and the aromatic oligomer. The content of the aromatic oligomer per 100 parts by weight of the polyvalent phenolic compound is in the range from 3 to 200 parts by weight, preferably from 5 to 100 parts by weight, more preferably from 10 to 80 parts by weight. A content lower than this would produce a small effect of modifying the properties toward lower moisture absorption, higher heat resistance, adhesiveness and flame retardance and lower dielectric property while a content higher than this would raise the viscosity and deteriorate the moldability.

A polyvalent phenolic compound here refers to any compound which contains two or more phenolic hydroxyl groups in the molecule and includes any of phenolic resins and polyvalent phenols.

Polyvalent phenolic compounds include divalent phenols, tri- and higher-valent phenols and phenolic resins synthesized from monovalent or multivalent phenols and crosslinking agents (aldehydes, ketones, divinyl compounds, dialkoxy compounds, dialkyl ethers and the like).

The divalent phenols include bisphenol A, bisphenol F, bisphenol S, fluorenebisphenol, 4,4′-biphenol, 2,2′-biphenol, hydroquinone, resorcin and naphthalenediol.

The tri- and higher-valent phenols include tris(4-hydroxyphenyl)methane and 1,1,2,2-tetrakis(4-hydroxyphenyl)ethane.

The phenolic resins include those resins which are synthesized by the reaction of monovalent or divalent phenols with crosslinking agents; the phenols are exemplified by phenol and its derivatives, naphthol and its derivatives, bisphenol A, bisphenol F, bisphenol S, fluorenebisphenol, 4,4′-biphenol, 2,2′-biphenol, hydroquinone, resorcin and naphthalenediol while the crosslinking agents are exemplified by formaldehyde, acetaldehyde, benzaldehyde, p-hydroxybenzaldehyde, p-xylylene glycol, p-xylylene glycol dimethyl ether, 4,4′-dimethoxymethylbiphenyl, 4,4′-dimethoxymethyldiphenyl ether, divinylbenzene and its derivatives, divinylbiphenyl and its derivatives and divinylnaphthalene and its derivatives. Moreover, the phenolic resins include polyvinylphenol resins, typically polyvinylphenol.

Preferable among the aforementioned polyvalent phenolic compounds are phenolic resins. Preferable among the phenolic resins for ease of control of the molecular weight distribution of the aromatic oligomer are a) novolak resin selected from phenol novolak, o-cresol novolak and naphthol novolak and b) phenol-aralkyl resin or naphthol-aralkyl resin synthesized by the reaction of a phenolic compound selected from phenols and naphthols with a crosslinking agent selected from p-xylylene glycol, p-xylene glycol dimethyl ether, 4,4′-dimethoxymethylbiphenyl, 4,4′-dimethoxymethyldiphenyl ether, divinylbenzenes, divinylbiphenyls and divinylnaphthalene. The softening point of phenolic resins is ordinarily in the range of 40-200° C., preferably 60-150° C. When a phenolic resin with a softening point lower than this is used as a curing agent for epoxy resin, the epoxy resin yields a cured porduct of lower heat resistance. On the other hand, a phenolic resin with a softening point higher than this shows poorer miscibility with an aromatic oligomer.

The phenolic resin composition of this invention is prepared, for example, by melt mixing where the components are uniformly mixed by agitation or kneading at a temperature which is higher than the softening point of either the polyvalent phenolic compound or the aromatic oligomer or by solution mixing where each component is respectively dissolved in a solvent and the resulting solutions are uniformly mixed by agitation or kneading. Solvents useful for the technique of solution mixing are alcohols such as methanol, ethanol, propanol, butanol, ethylene glycol, Methyl Cellosolve and Ethyl Cellosolve, ketones such as acetone, methyl ethyl ketone and methyl isobutyl ketone, ethers such as dimethyl ether, diethyl ether, diisopropyl ether, tetrahydrofuran and dioxane and aromatics such as benzene, toluene, xylene, chlorobenzene and dichlorobenzene. Epoxy resin, inorganic fillers, other phenolic resins and other additives can also be incorporated during the preparation of this composition.

The phenolic resin composition of this invention can also be prepared by polymerizing monomers which mainly consist of aromatic olefins comprising 20 wt % or more of acenaphthylenes in a polyvalent phenolic compound such as phenolic resin. This polymerization may be carried out under heat in the presence or absence of a catalyst. The temperature during polymerization is normally 60-200° C., preferably 80-160° C. The polymerization takes a longer time to finish at a temperature lower than this while the rate of reaction increases so that the reaction becomes difficult to control at a temperature higher than this. The polymerization time is normally 1-20 hours.

The aforementioned reaction can be carried out in the presence or absence of a solvent. In case a solvent is used, examples of such solvents include alcohols such as methanol, ethanol, propanol, butanol, ethylene glycol, Methyl Cellosolve and Ethyl Cellosolve, ketones such as acetone, methyl ethyl ketone and methyl isobutyl ketone, ethers such as dimethyl ether, diethyl ether, diisopropyl ether, tetrahydrofuran and dioxane and aromatic compounds such as benzene, toluene, chlorobenzene and dichlorobenzene.

The polyvalent phenolic compound to be used in the reaction is any of the aforementioned compounds containing two or more phenolic hydroxyl groups in the molecule, preferably polyfunctional phenolic resins having a molecular weight distribution. Among such polyfunctional phenolic resins, particularly preferable are phenol novolaks, phenol-aralkyl resins, naphthol novolaks and naphthol-aralkyl resins. Phenolic resins normally show a softening point of 40-200° C. and those with a softening point of 60-150° C. are preferable. In case a phenolic resin with a softening point lower than this is used as a curing agent for epoxy resin, the cured product deteriorates in heat resistance. On the other hand, a phenolic resin with a softening point higher than this shows poorer miscibility with aromatic oligomers.

The phenolic resin composition to be prepared in the aforementioned reaction is preferably controlled to contain 3-200 parts by weight of the aromatic oligomer per 100 parts by weight of the phenolic resin; it is nearly equal to the phenolic resin composition prepared by mixing the aromatic oligomer and the polyvalent phenolic compound and is used in the same manner, but it occasionally contains the reaction products of the aromatic olefins with the polyvalent phenolic compound in small amounts as byproducts. These phenolic resin compositions are useful as curing agents for epoxy resins.

The aromatic oligomer of this invention needs to show a softening point of 80-250° C. (in accordance with the ring and ball method, JIS K-6911) and, besides, preferably shows a number average molecular weight of 400-4,000 and a weight average molecular weight of 500-5,000.

The epoxy resin composition of this invention comprises at least epoxy resin, a curing agent and a modifier and the aforementioned aromatic oligomer is incorporated as a modifier. The amount of the aromatic oligomer to be incorporated in the composition is usually in the range of 3-200 parts by weight, preferably 5-50 parts by weight, per 100 parts by weight of the epoxy resin. An amount smaller than this would be less effective for improving the properties relating to moisture absorption, adhesiveness and flame retardance while an amount greater than this would deteriorate the moldability and reduce the strength of cured product. Other modifiers may be incorporated as needed and, in such a case as well, the aromatic oligomer is incorporated preferably in the aforementioned amount.

Epoxy resin to be used in the epoxy resin composition of this invention is selected from compounds which have two or more epoxy groups in the molecule; for example, glycidyl ethers of divalent phenols such as bisphenol A, bisphenol F, bisphenol S, fluorenebisphenol, 4,4′-biphenol, 2,2′-biphenol, tetrabromobisphenol A, hydroquinone and resorcin and glycidyl ethers of tri- and higher-valent phenolic compounds such as novolak resins of tris(4-hydroxyphenyl)methane, 1,1,2,2-tetrakis(4-hydroxyphenyl)ethane, novolak resin based on phenol, cresol or naphthol and aralkyl resins based on phenol, cresol or naphthol. These epoxy resins can be used singly or as a mixture of two kinds or more.

A curing agent to be used in the epoxy resin composition of this invention can be any of the curing agents generally known for epoxy resins; for example, dicyandiamide, acid anhydrides, polyvalent phenols and aromatic and aliphatic amines. In the area of usage such as encapsulants of semiconductors where high electrical insulating quality is required, polyvalent phenols are preferably used as curing agents. Concrete examples of curing agents are given below.

Acid anhydrides include phthalic anhydride, tetrahydrophthalic anhydride, methyltetrahydrophthalic anhydride, hexahydrophthalic anhydride, methylhexahydrophthalic anhydride, methylhimic anhydride, dodecenylsuccinic anhydride, nadic anhydride and trimellitic anhydride.

Polyvalent phenols include divalent phenols such as bisphenol A, bisphenoI F, bisphenol S, fluorenebisphenol, 4,4′-biphenol, 2,2′-biphenol, hydroquinone, resorcin and naphthalenediol, tri- and higher-valent phenols such as tris(4-hydroxyphenyl)methane, 1,1,2,2 -tetrakis (4-hydroxyphenyl)ethane, phenol novolak, o-cresol novolak, naphthol novolak and polyvinylphenol and polyvalent phenolic compounds synthesized from phenols, naphthols or divalent phenols such as bisphenol A, bisphenol F, bisphenol S, fluorenebisphenol, 4,4′-biphenol, 2,2′-biphenol, hydroquinone, resorcin and naphthalenediol by the use of a condensing agent such as formaldehyde, acetaldehyde, benzaldehyde, p-hydroxybenzaldehyde and p-xylylene glycol.

The phenolic resin composition of this invention, when incorporated, performs a dual function of curing agent and modifier. In this case, the amount of the aromatic oligomer in the phenolic resin composition is controlled at 3-200 parts by weight per 100 parts by weight of epoxy resin.

Amines include aromatic amines such as 4,4′-diaminodiphenylmethane, 4,4′-diaminodiphenylpropane, 4,4′-diaminodiphenyl sulfone, m-phenylenediamine and p-xylylenediamine and aliphatic amines such as ethylenediamine, hexamethylenediamine, diethylenetriamine and triethylenetetramine.

The curing agents are incorporated in the epoxy resin composition of this invention singly or as a mixture of two kinds or more.

In the epoxy resin composition of this invention, the epoxy resin and the curing agent are incorporated in such a manner as to balance the equivalence of the two functional groups; the equivalent ratio of epoxy resin to curing agent is normally in the range of 0.8-1.2, preferably 0.9-1.1.

Furthermore, it is allowable to incorporate oligomers or polymeric compounds such as polyesters, polyamides, polyimides, polyethers, polyurethanes, petroleum resins and phenoxy resins in the epoxy resin composition of this invention in a suitable amount as another modifier. The addition is made at a rate of 2-30 parts by weight per 100 parts by weight of epoxy resin.

It is also allowable to incorporate additives such as inorganic fillers, pigments, flame retardants, thixotropic agents, coupling agents and flow modifiers in the epoxy resin composition of this invention. Inorganic fillers include silica powder such as spherical or crushed fused silica and crystalline silica, alumina powder, glass powder, mica, talc, calcium carbonate, alumina and hydrated alumina. An inorganic filler, when used in encapsulants of semiconductors, is incorporated preferably in an amount of 70 wt % or more, more preferably 80 wt % or more.

Pigments include organic or inorganic extender pigments and scaly pigments. Thixotripic agents include silicones, castor oil, aliphatic amide wax, polyethylene oxide wax and bentonite.

Incorporation of any of known curing accelerators in the epoxy resin composition of this invention is permissible as occasion demands. Such curing accelerators include amines, imidazoles, phosphines and Lewis acids and their concrete examples include the following compounds: tertiary amines such as 1,8-diazabicyclo(5,4,0)undecene-7, triethylenediamine, benzyldimethylamine, triethanolamine, dimethylaminoethanol and tris(dimethylaminomethyl)phenol; derivatives of imidazole such as 2-methylimidazole, 2-phenylimidazole, 2-phenyl-4-methylimidazole and 2-heptadecylimidazole; derivatives of phosphine such as tributylphosphine, methyldiphenylphosphine, triphenylphosphine, diphenylphosphine and phenylphosphine; tetra-substituted borate of tetra-substituted phosphonium such as tetraphenylphosphonium tetraphenylborate, tetraphenylphosphonium ethyltriphenylborate and, tetrabutylphosphonium tetrabutylborate; and tetraphenylborates such as 2-ethyl-4-methylimidazole tetraphenylborate and N-methylmorpholine tetraphenylborate. The curing accelerator is added at a rate of 0.2-5 parts by weight per 100 parts by weight of epoxy resin.

Furthermore, as occasion demands, it is allowable to incorporate in the epoxy resin composition of this invention a parting agent such as carnauba wax and OP Wax, a coupling agent such as γ-glycidoxypropyltrimethoxysilane, a colorant such as carbon black, a flame retardant such as antimony trioxide, a stress reducing agent such as silicone oil and a lubricant such as calcium stearate.

Still more, the epoxy resin composition of this invention is dissolved in an organic solvent to form a varnish and a fibrous material such as glass cloth, unwoven aramid fabric and unwoven polyester (such as liquid polyester) fabric is impregnated with the varnish and stripped of the solvent to yield a prepreg. If circumstances require, the varnish is applied to form a layer of film on a sheet such as copper foil, stainless steel foil, polyimide film and polyester film to form a laminate.

The epoxy resin composition of this invention can be cured by heating and the cured product exhibits low moisture absorption, high heat resistance, good adhesiveness and good flame retardance.

### BRIEF DESCRIPTION OF THE DRAWINGS

FIG. 1 is the GPC (gel permeation chromatography) chart of aromatic oligomer A.

FIG. 2 is the infrared absorption spectrum of aromatic oligomer A.

FIG. 3 is the GPC chart of aromatic oligomer B.

FIG. 4 is the GPC chart of phenolic resin composition A.

FIG. 5 is the GPC chart of phenolic resin composition B.

FIG. 6 is the GPC chart of phenolic resin composition C.

### PREFERRED EMBODIMENTS OF THE INVENTION

This invention will be described concretely below with reference to the examples.

### EXAMPLE 1

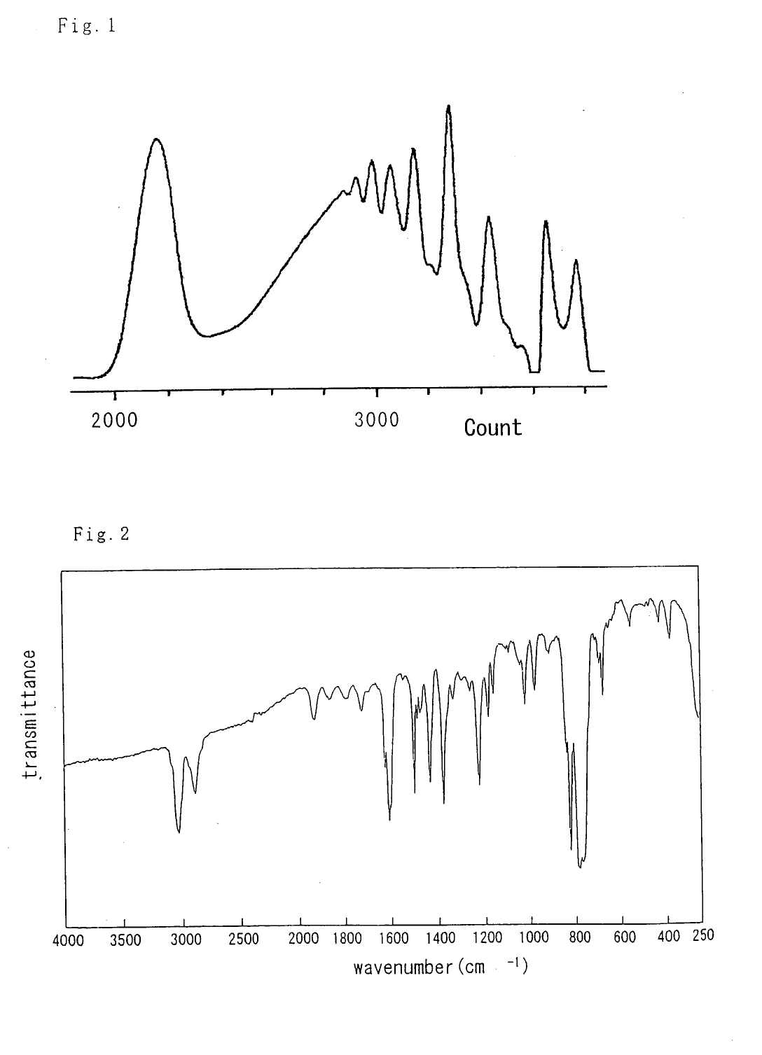

In 300 g of xylene was dissolved 100 g of acenaphthylene and heated to 130° C. Thereafter, 0.5 g of boron trifluoride-dimethyl ether complex was added dropwise with stirring to the solution over a period of 15 minutes. After the addition was over, the reaction was allowed to proceed for another 3 hours. Then, the reaction mixture was neutralized by addition of 1.5 g of calcium hydroxide. The salt formed by neutralization and the excess calcium hydroxide were removed by filtration and the filtrate was stripped of the xylene and the unreacted monomer by distillation under reduced pressure to give 94 g of an aromatic oligomer (oligomer A). The oligomer showed a softening point of 152° C. and a viscosity of 0.06 Pa·s at 25° C. in toluene (50 wt % solution). The amount of residual monomer determined by GPC was 3 wt %. The GPC chart and infrared absorption spectrum are respectively shown in FIGS. 1 and 2.

In the examples, the viscosity was determined by the use of an E type viscometer and the softening point was determined in accordance with the ring and ball method specified in JIS K-6911. The conditions for GPC measurement were as follows: apparatus, HLC-82A (a product of Tosoh Corporation); columns, TSK-GEL2000×3 and TSK-GEL4000×1 (products of Tosoh Corporation); solvent, tetrahydrofuran; flow rate, 1 ml/min; temperature, 38° C.; detector, RI; calibration, standard solution of polystyrene.

### EXAMPLE 2

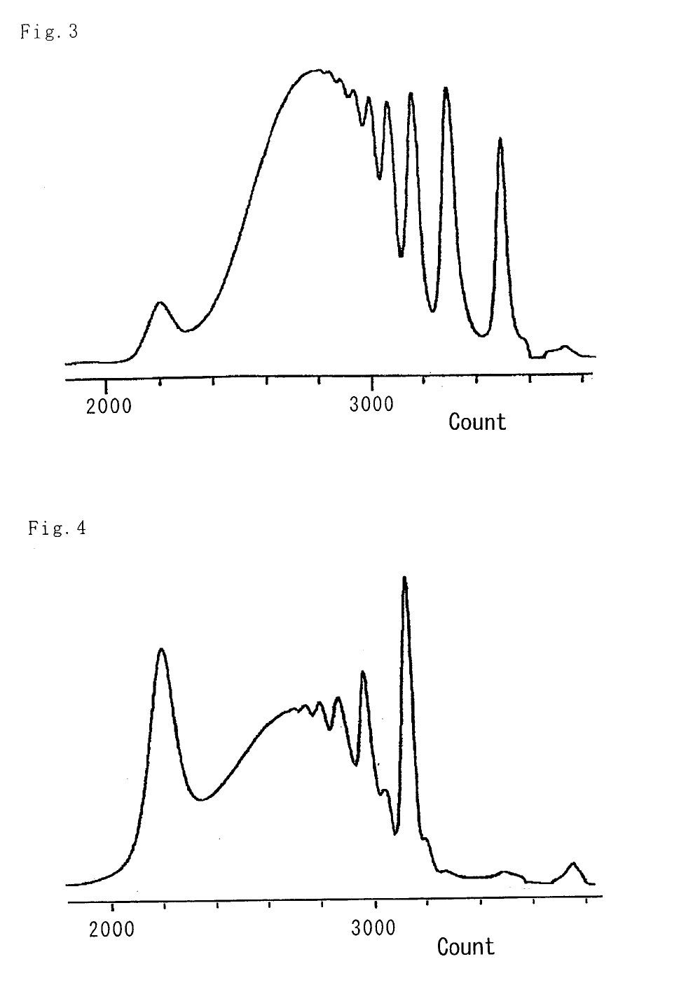

The reaction was carried out as in Example 1 by the use of 50 g of acenaphthylene and 50 g of indene to give 87 g of an aromatic oligomer (oligomer B). The oligomer showed a softening point of 140° C. and a viscosity of 0.1 Pa·s at 25° C. in toluene (50 wt % solution). The GPC chart is shown in FIG. 3.

### EXAMPLE 3

To 160 g of phenol novolak (softening point, 82° C.) which had been molten at 150° C. was added 40 g of acenaphthylene, molten uniformly, heated to 200° C. with stirring and allowed to react for 9.5 hours to give 198 g of a phenolic resin composition (composition A). The composition showed a softening point of 89° C. and a melt viscosity of 0.38 Pa·s at 150° C. The amount of residual acenaphthylene was 0.4 % as determined by GPC. The GPC chart is shown in FIG. 4.

### EXAMPLE 4

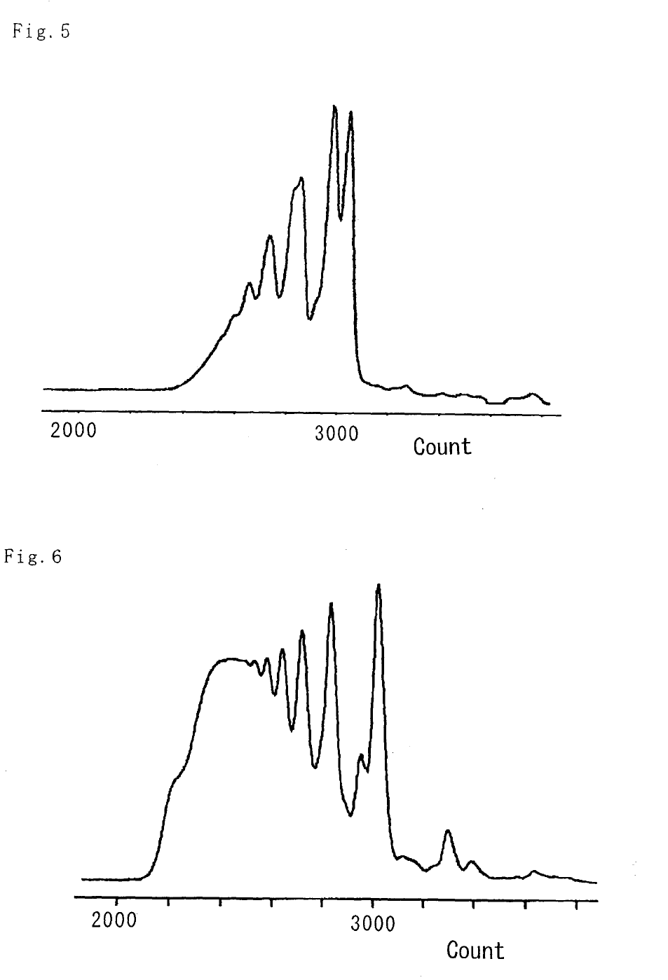

The procedure of Example 3 was repeated by the use of 1-naphthol-aralkyl resin with a softening point of 90° C. (SN-485; available from Nippon Steel Chemical Co., Ltd.) and the reaction was allowed to proceed at 200° C. for 4 hours to give 196 g of a phenolic resin composition (composition B). The composition showed a softening point of 111° C. and a melt viscosity of 1.7 Pa·s at 150° C. The amount of residual acenaphthylene was 0.2% as determined by GPC. The GPC chart is shown in FIG. 5.

### EXAMPLE 5

The procedure of Example 3 was repeated by the use of phenol-aralkyl resin with a softening point of 74° C. (XL-225-LL, available from Mitsui Chemicals, Inc.) and the reaction was allowed to proceed for 4 hours at 150° C. to give 196 g of a phenolic resin composition (composition C). The composition showed a softening point of 88° C. and a melt viscosity of 0.27 Pa·s at 150° C. The amount of residual acenaphthylene was 0.6% as determined by GPC. The GPC chart is shown in FIG. 6.

### EXAMPLES 6-11 AND COMPARATIVE EXAMPLES 1-4

Epoxy resin compositions were formulated by kneading the following components (in part by weight) at the ratio shown in Table 1: the aromatic oligomers obtained in Examples 1 and 2 (oligomers A and B) and an indene oligomer (oligomer C; IP-120 available from Nippon Steel Chemical Co., Ltd., softening point 121° C.) as modifier; o-cresol novolak epoxy resin (epoxy equivalent 200, softening point 70° C.) as epoxy resin; phenol novolak (curing agent A; OH equivalent 103, softening point 82° C.), 1-naphthol-aralkyl resin (curing agent B; SN-485 available from Nippon Steel Chemical Co., Ltd., OH equivalent 210, softening point 90° C.), phenol-aralkyl resin (curing agent C; XL-225-LL available from Mitsui Chemicals, Inc., OH equivalent 172, softening point 74° C.), and the phenolic resin compositions obtained in Examples 3-5 (compositions A, B and C) as curing agent; silica (average particle diameter 22 μm) as filler; and triphenylphosphine as curing accelerator. These epoxy resin compositions were molded at 175° C. and postcured at 175° C. for 12 hours and the specimens of the cured compositions thus obtained were tested for a variety of properties.

The glass transition temperature was determined with the aid of a thermomechanical analyzer at a rate of temperature rise of 10° C./min. The water absorption was determined by molding a disk, 50 mm in diameter and 3 mm in thickness, from respective epoxy resin composition, postcuring the disk and letting the disk absorb moisture at 133° C. and 3 atm. for 96 hours. The adhesiveness was evaluated by compression-molding respective epoxy resin composition on a copper foil at 175° C., postcuring at 175° C. for 12 hours and measuring the peel strength. The flame retardance was evaluated in accordance with UL94-V-0 by molding a test specimen with a thickness of 1/16 inch and the result is expressed in the sum total of the burning times of 5 test specimens.

The test results are shown in Table 2.

TABLE 1

| | Example | | | | | | Comparative example | | | |
|---|---|---|---|---|---|---|---|---|---|---|
| | 6 | 7 | 8 | 9 | 10 | 11 | 1 | 2 | 3 | 4 |
| Epoxy resin | 99 | 99 | 99 | 90 | 65 | 72 | 99 | 73 | 81 | 99 |
| Curing agent A | 51 | 51 | 51 | — | — | — | 51 | — | — | 51 |
| Curing agent B | — | — | — | — | — | — | — | 77 | — | |
| Curing agent C | — | — | — | — | — | — | — | — | 69 | |
| Composition A | — | — | — | 60 | — | — | — | — | — | — |
| Composition B | — | — | — | — | 85 | — | — | — | — | — |
| Composition C | — | — | — | — | — | 78 | — | — | — | — |
| Oligomer A | 10 | 30 | — | — | — | — | — | — | — | — |
| Oligomer B | — | — | 20 | — | — | — | — | — | — | — |
| Oligomer C | — | — | — | — | — | — | — | — | — | 20 |
| Silica | 450 | 450 | 450 | 450 | 450 | 450 | 450 | 450 | 450 | 450 |
| Curing | 1.5 | 1.5 | 1.5 | 1.5 | 1.5 | 1.5 | 1.5 | 1.5 | 1.5 | 1.5 |
| accelerator | | | | | | | | | | |

TABLE 2

| | Example | | | | | | Comparative example | | | |
|---|---|---|---|---|---|---|---|---|---|---|
| | 6 | 7 | 8 | 9 | 10 | 11 | 1 | 2 | 3 | 4 |
| Glass transition | 176 | 183 | 174 | 177 | 166 | 154 | 170 | 161 | 143 | 162 |
| temperature (° C.) | | | | | | | | | | |
| Thermal expansion | 1.6 | 1.6 | 1.6 | 1.4 | 1.5 | 1.8 | 1.6 | 1.5 | 1.7 | 1.8 |
| coefficient (<Tg, × 10⁻⁵) | | | | | | | | | | |
| Flexural strength (MPa) | 145 | 141 | 144 | 147 | 143 | 146 | 145 | 144 | 142 | 131 |
| Flexural modulus (GPa) | 16.8 | 17.3 | 17.4 | 17.2 | 17.1 | 17.3 | 16.5 | 16.8 | 16.4 | 16.6 |
| Adhesive strength | 1.8 | 1.7 | 1.9 | 2.1 | 2.4 | 2.1 | 1.2 | 1.6 | 1.4 | 1.7 |
| (kgf) | | | | | | | | | | |
| Water absorption (wt %) | 0.68 | 0.59 | 0.66 | 0.53 | 0.56 | 0.64 | 0.76 | 0.68 | 0.72 | 0.72 |
| Dielectric constant | 3.6 | 3.3 | 3.5 | 3.2 | 3.3 | 3.5 | 4.0 | 3.7 | 3.8 | 3.8 |
| (10⁶Hz) | | | | | | | | | | |
| Burning time (sec) | 238 | 130 | 271 | 187 | 62 | 76 | >400 | 280 | 354 | >400 |

Industrial Applicability

The aromatic oligomer of this invention is useful as a modifier for epoxy resin and an epoxy resin composition in which the oligomer is incorporated yields a cured product with high heat resistance and flame retardance, low moisture absorption, low dielectric property and good adhesion to a material of different kind and can be used advantageously in encapsulation of electric and electronic parts and as circuit board material.

What is claimed is:

1. An aromatic oligomer which is obtained by polymerizing monomers mainly containing aromatic olefins comprising 20 wt % or more of acenaphthylenes and shows a softening point of 80-250° C.

2. An aromatic oligomer as described in claim 1 wherein said oligomer is obtained by polymerizing aromatic olefins containing acenaphthylenes.

3. An aromatic oligomer as described in claim 1 wherein said oligomer is obtained by copolymerizing 20-90 wt % of acenaphthylenes and 10-80 wt % of a comonomer selected from indenes and styrenes.

4. A phenolic resin composition which comprises 3-200 parts by weight of the aromatic oligomer described in claim 1 per 100 parts by weight of a polyvalent phenolic compound.

5. A phenolic resin composition as described in claim 4 wherein the polyvalent phenolic compound is phenolic resin.

6. A method for manufacturing a phenolic resin composition which comprises polymerizing monomers mainly containing acenaphthylenes or of aromatic olefins comprising 20 wt % or more of acenaphthylenes in a polyvalent phenolic compound.

7. In an epoxy resin composition containing epoxy resin, a curing agent and a modifier, an epoxy resin composition wherein 3-200 parts by weight of the aromatic oligomer described in claim 1 is incorporated as a modifier per 100 parts by weight of epoxy resin.

8. In an epoxy resin composition containing epoxy resin, a curing agent and a modifier, an epoxy resin composition wherein the phenolic resin composition described in claim 4 is used as a curing agent and a modifier and 3-200 parts by weight of the aromatic oligomer is incorporated per 100 parts by weight of epoxy resin.

9. A cured product of epoxy resin obtained by curing the epoxy resin composition described in claim 7 or 8.
